(19) United States
(12) Patent Application Publication
(10) Pub. No.: US 2015/0112455 A1
(43) Pub. Date: Apr. 23, 2015

(54) CONTROL DEVICE WITH AUTOMATIC ADJUSTMENT

(71) Applicant: LITE-ON TECHNOLOGY CORPORATION, Taipei (TW)

(72) Inventors: Ching-Hsien LIN, Taipei (TW); Ming-Hung HUANG, Taipei (TW); Chia-Ming Hung, Taipei (TW)

(21) Appl. No.: 14/329,220

(22) Filed: Jul. 11, 2014

(30) Foreign Application Priority Data
Oct. 22, 2013 (TW) 102138078

(51) Int. Cl. G05B 13/02; G06N 99/00

(52) U.S. Cl. CPC G05B 13/0205; G06N 99/005
USPC 700/47; 700/28

(57) ABSTRACT

A control device with automatic adjustment includes: a GPS module, for receiving a GPS satellite information; and a microcontroller unit, coupled to the GPS module. The microcontroller unit updates a control setting value based on the GPS satellite information from the GPS module, and the microcontroller unit controls a controlled device based on the control setting value.

This application claims the benefit of Taiwan application Serial No. 102138078, filed Oct. 22, 2013, the subject matter of which is incorporated herein by reference.

### BACKGROUND

1. Technical Field

The disclosure relates in general to a control device, and more particularly to a control device with automatic adjustment.

2. Description of the Related Art

A control device controls a controlled device (for example, a lamp, a motor, and a solenoid valve) according to default turned-on conditions. The turned-on conditions include a time condition and/or a luminance condition, etc. The time condition, for example, refers to a time point at which the control device controls the controlled device, such as turning on/off the controlled device. The luminance condition, for example, refers to that, when the luminance is under/above a luminance threshold, the control device performs a corresponding control operation.

When the time condition is used as a turned-on condition for controlling the controlled device, the control device includes a counter which counts time and provides the time information. Once the time information provided by the counter meets the default time condition, the control device will perform a corresponding control operation on the controlled device.

When the luminance condition is used as a turned-on condition for controlling the controlled device, the control device includes an ambient light sensor (ALS) which senses an ambient luminance, so that the control device performs a relevant operation according to the sensed luminance information. Once the sensed luminance information meets a default luminance condition, the control device will perform a corresponding control operation on the controlled device.

The control devices are widely used. Therefore, how to maintain the reliability and convenience of the control device has become a prominent task for people in the related technology.

### SUMMARY OF THE DISCLOSURE

The disclosure is directed to a control device with automatic adjustment, which adjusts or updates a control setting value based on information provided by a GPS (Global Positioning System) module, so as to increase the reliability and installation convenience of the control device.

According to one embodiment of the present disclosure, a control device with automatic adjustment is provided. The control device includes a GPS module and a microcontroller unit. The GPS module receives a GPS satellite information. The microcontroller unit is coupled to the GPS module for updating a control setting value based on the GPS satellite information and controlling at least a controlled device based on the control setting value.

The above and other contents of the disclosure will become better understood with regard to the following detailed description of the preferred but non-limiting embodiment(s). The following description is made with reference to the accompanying drawings.

### BRIEF DESCRIPTION OF THE DRAWINGS

FIG. 1 is a block diagram of a control device with automatic adjustment according to an embodiment of the disclosure.

### DETAILED DESCRIPTION OF THE DISCLOSURE

Technical terms of the disclosure are based on general definition in the technical field of the disclosure. If the disclosure describes or explains one or some terms, definition of the terms is based on the description or explanation of the disclosure. Description on the common technologies or theories is omitted if they do not involve the technical features of the disclosure. Further, shapes, sizes and ratios of the objects are exemplary for one skilled person in the art to understand the disclosure, not to limit the disclosure.

Each of the disclosed embodiments has one or more technical features. In possible implementation, one skilled person in the art would selectively implement part or all technical features of any embodiment of the disclosure or selectively combine part or all technical features of the embodiments of the disclosure.

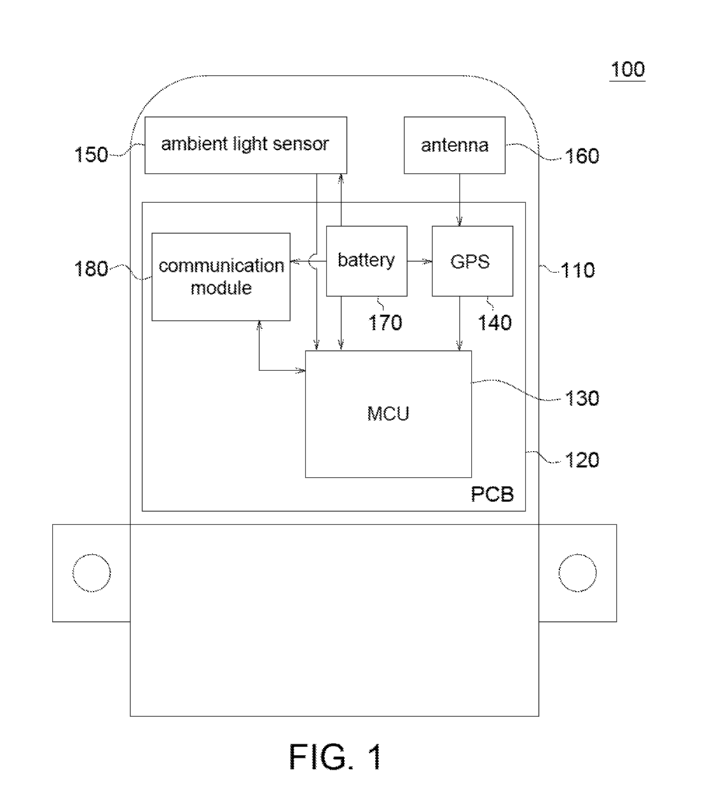

Referring to FIG. 1, a block diagram of a control device with automatic adjustment according to an embodiment of the disclosure is shown. As indicated in FIG. 1, the control device 100 with automatic adjustment includes a housing 110, a circuit board (such as a printed circuit board (PCB)) 120, a microcontroller unit (MCU) 130, a GPS module 140, an ambient light sensor 150, antenna 160 and a battery 170. Besides, the control device 100 may selectively include a communication module 180.

The housing 110 is a waterproof housing, such that even if the control device 100 is installed in an outdoor environment, by a window or under an arcade of a building, the electronic components of the control device 100 will not be moisturized and the lifespan of the electronic components may thus be prolonged.

The circuit board 120 is installed inside the housing 110. Electronic components, such as the microcontroller unit 130, the GPS module 140, the battery 170 and the communication module 180, are disposed on the circuit board 120.

The microcontroller unit 130 receives information from the GPS module 140, the ambient light sensor 150 and the communication module 180. Also, the microcontroller unit 130 may send out information, such as a location information, via the communication module 180. In the present disclosure, the microcontroller unit 130 is further equipped with a control function and an automatic adjustment function, and detailed descriptions of the microcontroller unit 130 are elaborated below. In short, the microcontroller unit 130 may update a control setting value based on information provided by the GPS module 140. The microcontroller unit 130 may adjust a time reference based on the control setting value, to control at least a controlled device (such as a lamp, a motor, a solenoid valve, and so on) or to control at least a controlled device (such as a lamp, a motor, a solenoid valve, and so on) based on the control setting value and the ambient luminance information from the ambient light sensor 150.

Suppose the microcontroller unit 130 is used to control the lamp based on the control setting value and the ambient luminance information from the ambient light sensor 150. The microcontroller unit 130 may control (turn on) the lamp to provide illumination if the microcontroller unit 130 determines that the ambient illumination is too dark (i.e. the ambient luminance information is lower than the control setting value) after comparing the control setting value with the ambient luminance information (representing a luminance of the sunlight) from the ambient light sensor 150.

The GPS module 140 receives satellite information (such as time information and location information) transmitted from a GPS satellite, and further transmits to the microcontroller unit 130. The GPS module 140 receives information from the GPS satellite via the antenna 160.

The ambient light sensor 150 senses an ambient luminance, and further transmits the sensing result (the ambient luminance information) to the microcontroller unit 130.

The battery 170 provides power to electronic components inside the control device 100. The electronic components are such as the microcontroller unit 130, the GPS module 140, the ambient light sensor 150 and the communication module 180. The battery 170 of the present embodiment is realized by a lithium battery, but the disclosure is not limited thereto.

The communication module 180 may be equipped with such as 3G communication function, Wi-Fi communication function, and so on. The communication module 180 is controlled by the microcontroller unit 130 to communicate with the external environment. In an embodiment, after the communication module 180 receives the location information of the control device 100 from the microcontroller unit 130, the communication module 180 sends out the location information of the control device 100 to an external control center. Thus, the external control center obtains the location of the control device 100 and the maintenance of the control device 100 is made more convenient.

Details of how the technical characteristics of the disclosure are made by the control device and the GPS module are disclosed below.

In an embodiment of the disclosure, the date and time information provided by the GPS module 140 may be used as an updated time reference (the control setting value), and the microcontroller unit 130 may periodically adjust the counter. For example, the microcontroller unit 130 adjusts the counter daily, but the disclosure is not limited thereto. By doing so, the error of the counter may be reduced to be as small as tens of milliseconds, and the accuracy in the time control on the controlled device may be improved. In an embodiment of the disclosure, the counter may be an internal component of the microcontroller unit 130 or a component independent from the microcontroller unit 130.

Besides, the microcontroller unit 130 may use the date and time information provided by the GPS module 140 as a reference, such that the control device 100, in conjunction with related firmware, may have the perpetual calendar and time control function even without additional hardware. Therefore, the perpetual calendar and time control function of the control device 100 will not be affected even if the counter is aged.

According to the above embodiments, the control device 100 may automatically adjust the time reference (the control setting value) based on the date and time information provided by the GPS module 140 to avoid control on the controlled device at wrong timing which is caused by the error of the counter, and to increase the reliability of the control device 100. Since the counter is normally realized by an oscillation component, aging of the counter will occur after a long duration of use.

Details of how the control device, the GPS module 140 and the ambient light sensor 150 achieve the technical characteristics of the disclosure are disclosed below.

In the present embodiment, the control device 100 achieves the “self-on-site learning” function by using the date and time information provided by the GPS module 140. In an embodiment, the microcontroller unit 130 may divide a day into a plurality of time sessions (such as 24 time sessions) based on the date and time information provided by the GPS module 140, and obtain the luminance information sensed by the ambient light sensor 150 at respective time session. The microcontroller unit 130 may obtain the luminance change over a whole day based on the time sessions and the luminance information of the time sessions to generate an updated time condition (the control setting value). For example, the microcontroller unit 130 may obtain a time session during which the ambient light gets dark based on the luminance change over a whole day, and accordingly adjusts the time condition based on the time session during which the ambient light gets dark.

In another embodiment, the microcontroller unit 130 may obtain the luminance information sensed by the ambient light sensor 150 at a specific time session for many days based on the date and time information provided by the GPS module 140. The microcontroller unit 130 performs statistical analysis on the above luminance information, and accordingly generates an updated luminance condition (the control setting value). For example, the microcontroller unit 130 may obtain a luminance information sensed by the ambient light sensor 150 at 6 pm for many days and further use the statistical value as an updated luminance condition. The statistic value is exemplified by an average value or a median value but the present embodiment is not limited thereto. Suppose the controlled device is a lamp. If the current ambient luminance is larger than the updated luminance condition, this means that the illumination is bright enough and the control device 100 will not turn on the lamp. Conversely, if the current ambient luminance is smaller than the updated luminance condition, this means that the illumination is not bright enough and the control device 100 will turn on the lamp.

A self-on-site learning operation is performed in an embodiment of the disclosure because the original control setting value may not be suitable for every location. Since the sun angle may be different from location to location, the luminance sensed at the same time session but different locations may not be the same. In the present embodiment, by performing a self-on-site learning operation, the averaged luminance value will gradually conform to the local luminance of the sunlight at the time session.

Conversely, suppose the default turned-on condition cannot be adjusted. When the ambient condition at an installation site has changed, the control device will still perform the control operation on the controlled device based on the default turned-on condition, which is no longer conformed to the already-changed ambient condition. Consequently, the control device may turn on the controlled device under an erroneous condition. However, the embodiment of the disclosure avoids the occurrence of such problems.

In addition, the ambient condition at each installation site is different.

If the self-on-site learning operation is unavailable, the respective default turned-on condition at each installation site must be manually set during the installation process, not only taking a considerable amount of time but also bringing tremendous inconvenience to the installation process. However, the embodiment of the disclosure avoids the occurrence of such problems.

Apart from sensing and obtaining local luminance information by using the ambient light sensor 150, in another embodiment of the disclosure, the turned-on condition (the control setting value) may further be compensated or fine-tuned based on the location information (the longitude/latitude information) provided by the GPS module 140 and a local ambient parameter. The local ambient parameter is such as sunrise/sunset time and/or sun angle information. In an embodiment of the disclosure, the microcontroller unit 130, based on the location information (the longitude/latitude information) provided by the GPS module 140, may obtain a local ambient parameter from a database. Then, the microcontroller unit 130 may calculate a compensation value based on the local ambient parameter to compensate or fine-tune the turned-on condition. In an embodiment of the disclosure, the database may be pre-stored in the control device 100 or may be searched by the microcontroller unit 130 through network.

The turned-on condition is compensated or fine-tuned in an embodiment of the disclosure because luminance may change dramatically when the sun sets in a flash. In the present embodiment, the microcontroller unit 130, based on the calculated information, determines whether to fine-tune the control setting value and to what degree will the control setting value be compensated or fine-tuned.

As disclosed in the above embodiments, the control device 100 may automatically adjust the turned-on condition (the control setting value) based on the date, time or location information provided by the GPS module to avoid manual adjustment of the turned-on condition at respective installation site, which reduces time and manual burden.

The control device of the embodiment of the disclosure is capable of adjusting or updating a control setting value (such as time reference, the turned-on condition and so on) based on the information provided by a GPS module so as to accordingly increase the reliability and installation convenience of the control device

While the disclosure has been described by way of example and in terms of the preferred embodiment(s), it is to be understood that the disclosure is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A control device with automatic adjustment, comprising:
a GPS module for receiving a GPS satellite information; and
a microcontroller unit coupled to the GPS module for updating a control setting value based on the GPS satellite information and for controlling at least a controlled device based on the control setting value.

2. The control device according to claim 1, further comprising:
an ambient light sensor for sensing an ambient luminance to obtain an ambient luminance information;
wherein, the microcontroller unit further controls the controlled device based on the control setting value and the ambient luminance information.

3. The control device according to claim 1, further comprising:
a waterproof housing;
a battery for providing power to the microcontroller unit and the GPS module; and
a circuit board installed inside the waterproof housing, wherein the microcontroller unit, the GPS module and the battery are disposed on the circuit board.

4. The control device according to claim 3, further comprising:
a communication module installed on the circuit board and powered by the battery, wherein the microcontroller unit transmits a location information provided from the GPS satellite information to the communication module, which sends out the location information.

5. The control device according to claim 1, wherein
the GPS satellite information is a time information;
the control setting value is a time reference; and
the microcontroller unit updates the time reference based on the time information for adjusting a counter.

6. The control device according to claim 1, wherein the GPS satellite information is a time information; and
the microcontroller unit performs a self-on-site learning operation based on the time information.

7. The control device according to claim 6, wherein the microcontroller unit divides a day into a plurality of time sessions;
the microcontroller unit reads a respective ambient luminance information at each time session; and
the microcontroller unit obtains a statistic value from the ambient luminance information at the time sessions and uses the statistic value as the control setting value.

8. The control device according to claim 6, wherein
the microcontroller unit reads a plurality of ambient luminance information corresponding to a specific time session in a plurality of days based on the time information provided by the GPS module; and
the microcontroller unit obtains a statistic value from the ambient luminance information and uses the statistic value as the control setting value.

9. The control device according to claim 1, wherein the GPS satellite information includes a location information, the control setting value is a turned-on condition, and the microcontroller unit obtains a local ambient parameter based on the location information and updates the turned-on condition based on the local ambient parameter.

10. The control device according to claim 9, wherein the local ambient parameter comprises at least one of a sunrise/sunset time information and a sun angle information.
